(19) United States
(12) Patent Application Publication
(10) Pub. No.: US 2024/0412568 A1
(43) Pub. Date: Dec. 12, 2024

(54) ELECTRONIC DEVICE MOUNTED IN AUTONOMOUS VEHICLE, ELECTRONIC SYSTEM INCLUDING THE SAME, AND OPERATING METHOD THEREOF

(71) Applicant: SAMSUNG ELECTRONICS CO., LTD., Suwon-si (KR)

(72) Inventors: Jinwook Lee, Suwon-si (KR); Sang-Hwa Jin, Suwon-si (KR); Seungcheol Lee, Suwon-si (KR)

(21) Appl. No.: 18/678,335

(22) Filed: May 30, 2024

(30) Foreign Application Priority Data
Jun. 8, 2023 (KR) 10-2023-0073610

(51) Int. Cl. G07C 5/00; B60R 16/033; G07C 5/08; H02J 7/00

(52) U.S. Cl. CPC G07C 5/008; B60R 16/033; G07C 5/0808; H02J 7/007194

(57) ABSTRACT

The present disclosure relates to electronic devices. An example electronic device installed in a vehicle includes a communication interface and a data retention circuit that communicates through the communication interface. The data retention circuit estimates a temperature of a storage device based on information about an outside temperature received through the communication interface and a preset temperature offset, and determines a data management period of the storage device in an off state based on the estimated temperature of the storage device and a data retention parameter.

### CROSS-REFERENCE TO RELATED APPLICATION

This application claims priority under 35 U.S.C. § 119 to Korean Patent Application No. 10-2023-0073610 filed on Jun. 8, 2023, in the Korean Intellectual Property Office, the disclosures of which are incorporated by reference herein in their entireties.

BACKGROUND

Nowadays, a storage device, which uses a memory device, such as a solid state drive (SSD) is being widely used. Because the storage device does not include a mechanical driving unit, the storage device provides excellent stability and endurance and is advantageous in that a speed to access information is very fast and power consumption is small.

Nowadays, vehicle to everything (V2X) communication for sending and/or receiving data through a wired and/or wireless communication network is being used in a vehicle. The V2X communication makes it possible to send and/or receive data for autonomous driving of the vehicle and to update high-definition map data (e.g., HD map) and to update an automotive operating system in an over the air (OTA) manner.

The storage device is being used in the autonomous vehicle to store data sensed through a camera, a light detection and ranging (LIDAR) sensor, and a Radar and/or data received from a cloud server.

The storage device may include a nonvolatile memory device. When the vehicle is parked, a power that is supplied to the storage device may be cut off for a long time. In the power-off state of the storage device, the reliability of data stored therein may decrease depending on an exposed temperature and a duration of the power-off state.

### SUMMARY

The present disclosure relates to electronic devices, including an electronic device capable of reducing power consumption of a storage device and improving the reliability of data stored in the storage device to be mounted in an autonomous vehicle, electronic systems including the same, and operating methods thereof.

In general, in some aspects, the subject matter of the present disclosure relates to an electronic device installed in a vehicle, in which the electronic device includes a communication interface, and a data retention manager that communicates with the outside through the communication interface. The data retention manager estimates a temperature of a storage device based on information about an outside temperature received through the communication interface and a preset temperature offset, and determines a data management period of the storage device in an off state based on the estimated temperature of the storage device and a data retention parameter.

In general, in some other aspects, the subject matter of the present disclosure relates to an electronic system that includes an electronic device installed in a vehicle, in which the electronic system also includes a battery system, and a storage device. The electronic device estimates a temperature of the storage device based on information about an outside temperature received and a preset temperature offset, determines a data management period of the storage device in an off state based on the estimated temperature of the storage device and a data retention parameter, and outputs a battery control signal for supplying a power to the storage device in the off state and outputs a data retention management signal to the storage device, when the data management period is reached. The battery system supplies the power to the storage device of the off state in response to the battery control signal, and the storage device performs a data management operation in response to the data retention management signal.

In general, in some other aspects, the subject matter of the present disclosure relates to an operating method of an electronic device installed in a vehicle, in which the operating method includes receiving information about an outside temperature, estimating a temperature of a storage device based on the outside temperature and a preset temperature offset, determining a data management period of the storage device in an off state based on the estimated temperature of the storage device and a data retention parameter, and outputting a battery control signal to a battery system and outputting a data management signal to the storage device, when the data management period is reached.

### BRIEF DESCRIPTION OF THE FIGURES

The above and other objects and features of the present disclosure will become apparent by describing in detail implementations thereof with reference to the accompanying drawings.

FIG. 1 is a block diagram illustrating an example electronic system.

FIG. 2 is a block diagram illustrating an example electronic device of FIG. 1.

FIG. 3 is a block diagram illustrating an example storage device of FIG. 1.

FIG. 4 is an example diagram for describing a threshold voltage change of memory cells caused in a storage device left alone for a long time in an off state.

FIG. 5 is an example flowchart for describing an operation of an electronic system.

FIGS. 6A and 6B are diagrams for describing an example of an operation in which an electronic device estimates a temperature of a storage device.

FIG. 7 is a diagram for describing another example of an operation in which an electronic device estimates a temperature of a storage device.

FIG. 8 is a graph illustrating an example of data retention time according to a temperature of a storage device.

FIG. 9 is a diagram illustrating an example exposure time table.

FIG. 10 is a diagram illustrating an example reaction amount according to an exposure time table of FIG. 9.

FIG. 11 is a diagram for describing an example of an operation in which an electronic device estimates a temperature of a storage device for each of a plurality of time periods. FIG. 12 is a diagram illustrating an example scale factor table.

FIG. 13 is a diagram for describing an example of an operation in which an electronic device determines a data management period based on a temperature of a storage device for each of a plurality of time periods.

FIG. 14 is a diagram for describing an example of a data management operation that a storage device performs.

FIG. 15 is a diagram for describing another example of a data management operation that a storage device performs.

FIG. 16 is a diagram for describing another example of a data management operation that a storage device performs.

FIG. 17 is a flowchart for describing an example of a data recovery operation that a storage device performs.

FIG. 18 is a diagram for describing an example of an operation in which an electronic device receives a defense code sequence.

FIGS. 19A and 19B are diagrams for describing an example of a defense code that an electronic device executes.

FIG. 20 is a flowchart illustrating an example operating method of an electronic device.

FIG. 21 is an example diagram illustrating communication of an electronic device installed in an autonomous vehicle.

### DETAILED DESCRIPTION

Implementations of the present disclosure will be described in detail with reference to the accompanying drawings, such that those skilled in the art would realize that the described implementations may be modified in various different ways, all without departing from the spirit or scope of the present disclosure.

While this specification contains many specific implementation details, these should not be construed as limitations on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

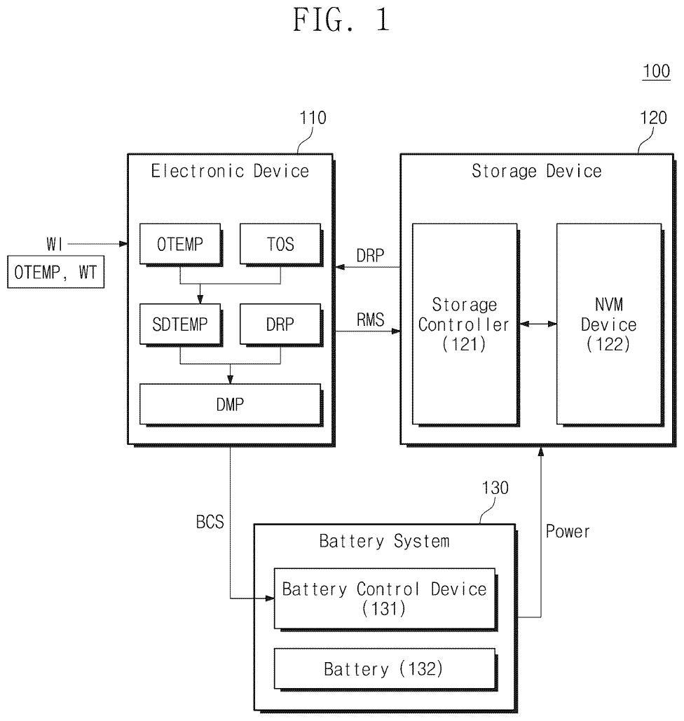

FIG. 1 is a block diagram illustrating an example electronic system. Referring to FIG. 1, an electronic system 100 includes an electronic device 110, a storage device 120, and a battery system 130, which are mounted in an autonomous vehicle.

The electronic device 110 may receive weather information WI including an outside temperature OTEMP. The electronic device 110 may estimate a temperature SDTEMP of the storage device 120 based on the received outside temperature OTEMP and a preset temperature offset TOS. The electronic device 110 may determine a data management period DMP of the storage device 120 based on the estimated temperature SDTEMP of the storage device 120 and a data retention parameter DRP.

When the data management period DMP is reached, the electronic device 110 may output a battery control signal BCS for supplying the power to the storage device 120 to the battery system 130 and may output a data retention management signal RMS to the storage device 120.

The weather information WI may include various kinds of information about a weather situation of the autonomous vehicle in which the electronic system 100 is mounted. For example, the weather information WI may include the outside temperature OTEMP and a weather type WT. The outside temperature OTEMP that is a temperature of the outside air may mean a temperature at which the autonomous vehicle is exposed. The weather type WT corresponds to a state of weather, in which a vehicle is exposed, such as clear, cloudy, rain, snow, and wind. The weather information WI may further include various kinds of information such as humidity, rainfall, and snowfall, in addition to the outside temperature OTEMP and the weather information WI.

The temperature offset TOS is an offset value that is used to estimate a temperature of the storage device 120 through the outside temperature OTEMP. The temperature offset TOS may correspond to a difference between the temperature SDTEMP of the storage device 120 and the outside temperature OTEMP when the autonomous vehicle is parked. The electronic device 110 may correct a temperature through a way to add the outside temperature OTEMP and the preset temperature offset TOS and thus may estimate the temperature SDTEMP of the storage device 120 in the off state without receiving the temperature of the storage device 120 from the storage device 120 in the off state.

The data retention parameter DRP is a parameter associated with the data retention capability of the storage device 120. The data retention parameter DRP may include an acceleration constant and a data retention time according to a reference temperature. The data retention time corresponds a time capable of guaranteeing the reliability of data stored in the storage device 120 in a reference temperature environment. The data retention time according to the reference temperature may change depending on a characteristic of the storage device 120, a purpose of the storage device 120, and an operating policy of the storage device 120. The acceleration constant that is a constant associated with a chemical reaction rate may be a value corresponding to the activation energy of the Arrhenius equation. In the storage device 120 including a flash memory, data retention depends on an exposed temperature and a time. According to the Arrhenius equation, as a temperature increases, the reaction rate of particles increases. The increased particle reaction rate affects the activation of electrons stored in the flash memory. Accordingly, the reduction of data retention may be caused depending on a temperature at which the storage device 120 is exposed. When the storage device 120 is left alone for a long time under an external condition of a high temperature or a low temperature, the reliability of data stored therein may decrease.

The data management period DMP corresponds to a time period from a time when the power of the storage device 120 is cut off to a time when a data management operation should be performed. When the data retention capability of the storage device 120 increases, the data management period DMP may increase. Meanwhile, as the temperature of the storage device 120 in the off state increases, the reaction rate, that is, a data degradation speed may increase, and thus, the data management period DMP may decrease.

The storage device 120 included in the electronic system 100 may include a storage controller 121 and a nonvolatile memory device 122.

The storage controller 121 may control an operation of the storage device 120. For example, the storage controller 121 may control an operation of the nonvolatile memory device 122 based on a command and data received from the electronic device 110.

The nonvolatile memory device 122 may store data in a non-transitory manner. For example, the nonvolatile memory device 122 may store metadata, user data, and various kinds of data generated in the autonomous vehicle.

The nonvolatile memory device 122 may include a NAND flash memory. The nonvolatile memory device 122 may include an EEPROM (Electrically Erasable Programmable Read-Only Memory), a PRAM (Phase Change Random Access Memory), an RRAM (Resistance Random Access Memory), an NFGM (Nano Floating Gate Memory), a PoRAM device (Polymer Random Access Memory), an MRAM (Magnetic Random Access Memory), an FRAM (Ferroelectric Random Access Memory), or any other memory similar thereto.

The data retention capability may change depending on an internal structure of the nonvolatile memory device 122, a physical property of the nonvolatile memory device 122, or an operating method of the storage device 120. In some implementations, the data retention capability of the nonvolatile memory device 122 whose integration is relatively high may be lower than the data retention capability of the nonvolatile memory device 122 whose integration is relatively low. Also, the data retention capability of the nonvolatile memory device 122 that stores data in a multi-level cell (MLC) manner may be lower than the data retention capability of the nonvolatile memory device 122 that stores data in a single level cell (SLC) manner. Accordingly, the data retention time or the acceleration constant according to the reference temperature may change depending on the characteristic of the nonvolatile memory device 122 included in the storage device 120 and an operating method of the storage controller 121. That is, the data retention parameter DRP may be variable.

The battery system 130 may include a battery control device 131 and a battery 132. The battery system 130 may be also referred to as an “energy storage system (ESS)”.

The battery control device 131 may monitor the status of the battery 132 and may control the battery 132. The battery control device 131 may perform thermal control of a plurality of battery modules included in the battery 132. Also, the battery control device 131 may prevent an over-charge and over-discharge situation of the battery 132 and may perform cell balancing such that charging states of the plurality of battery modules included in the battery 132 are evenly controlled. In response to a control signal from the electronic device 110, the battery control device 131 may control the battery 132 such that the power is capable of being supplied various kinds of devices of the autonomous vehicle. The battery control device 131 may be also referred to as a “battery management system (BMS)”.

The battery 132 may be able to supply the power to various kinds of devices of the autonomous vehicle installed with the battery system 130 and may include the plurality of battery modules. Each of the plurality of battery modules may include a plurality of cells. The plurality of battery modules may be mix-linked in series and parallel. The plurality of battery modules may be implemented with a secondary cell such as a lithium ion battery. Also, the plurality of battery modules may have the same capacity or may have different capacities.

The electronic device 110 may be implemented with a telematics control unit mounted in the autonomous vehicle.

In a state where the autonomous vehicle is parked, when the power is supplied continuously or very frequently to guarantee the reliability of data stored in the storage device 120, power consumption of the storage device 120 increases, and thus, the energy of the battery 132 is unnecessarily consumed. Meanwhile, in a state where the autonomous vehicle is parked, when the power is not supplied for a long time relative to the data retention capability of the storage device 120, data stored in the storage device 120 may be lost, and thus, the reliability of data may decrease.

In some implementations, the electronic device 110 mounted in the autonomous vehicle estimates the temperature SDTEMP of the storage device 120 in the power-off state based on the received outside temperature OTEMP and determines the data management period DMP based on the estimated temperature SDTEMP of the storage device 120. As such, the storage device 120 may perform the data management operation at an appropriate point in time, may guarantee the reliability of data stored in the storage device 120, and may minimize power consumption of the storage device 120.

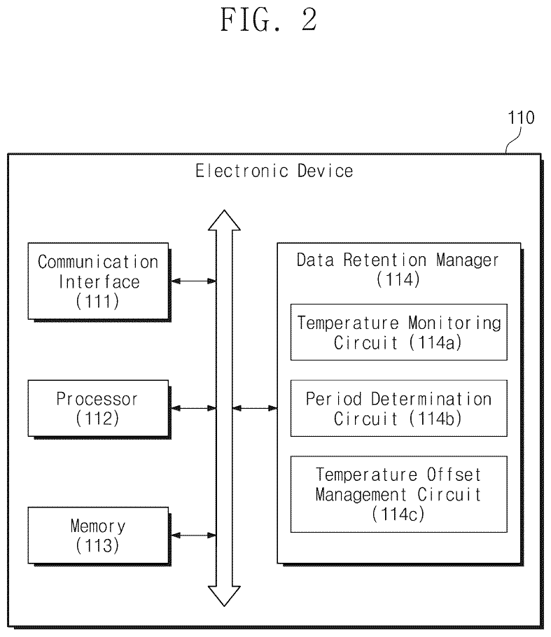

FIG. 2 is a block diagram illustrating an example electronic device of FIG. 1. Referring to FIG. 2, the electronic device 110 mounted in the autonomous vehicle includes a communication interface 111, a processor 112, a memory 113, and a data retention manager 114.

The communication interface 111 provides an interface that allows the electronic device 110 to send/receive various kinds of data to/from the outside. For example, the communication interface 111 may communicate with a cloud server or a data center through the vehicle to network (V2N) communication and may receive weather information including an outer temperature or a defense code sequence used for data recovery. In addition to weather information of a specific point in time when the weather information is received, the weather information received through the communication interface 111 may include weather information associated with a time period after the specific point in time and a time period before the specific point in time. The weather information associated with the time period before the specific point in time when the weather information is received may correspond to already measured weather information, and the weather information associated with the time period after the specific point in time when the weather information is received may correspond to a weather forecast. The weather information received through the communication interface 111 may further include various data associated with weather such as an outer temperature, a weather type, humidity, rainfall, or rainfall probability.

The communication interface 111 may include communication modules for supporting communication technologies such as fifth generation (5G) communication, long term evolution (LTE), and third generation (3G) communication.

The communication interface 111 may receive a navigation signal used to calculation a position of an autonomous vehicle, from at least one module for receiving satellite navigation signals of a GPS (Global Positioning System), a GLONASS (Global Navigation Satellite System), a Galileo GNSS, a BDS (Beidou Navigation Satellite System), an IRNSS (Indian Regional Navigational Satellite System), a QZSS (Quasi-Zenith Satellite System), etc.

The processor 112 may control various kinds of operations of the electronic device 110. The processor 112 may execute one or more instructions stored in the memory 113. The processor 112 may be implemented with a hardware component that performs arithmetic, logic, and input/output operations and signal processing. The processor 112 may be implemented, for example, with at least one of a central processing unit, a microprocessor, a graphic processing unit, an application specific integrated circuits (ASICs), a digital signal processors (DSPs), digital signal processing devices (DSPDs), programmable logic devices (PLDs), and field programmable gate arrays (FPGAs), but is not limited thereto.

The memory 113 may include, for example, a nonvolatile memory including at least one of a flash memory type, a hard disk type, a multimedia card micro type, a card-type memory (e.g., an SD or XD memory), a read-only memory (ROM), an electrically erasable programmable read-only memory (EEPROM), and a programmable read-only memory (PROM) and a volatile memory device such as a random access memory (RAM) or a static random access memory (SRAM).

Instructions readable by the processor 112, a data structure, and a program code may be stored in the memory 113.

The weather information WI received through the communication interface 111, the temperature offset TOS used to estimate a temperature of the storage device 120, the estimated temperature SDTEMP of the storage device 120, the data management period DMP, the data retention parameter DRP received from the storage device 120, an exposure time table, and a scale factor table may be stored in the memory 113.

The data retention manager 114 may estimate the temperature SDTEMP of the storage device 120 based on the outside temperature OTEMP and the preset temperature offset TOS and may determine the data management period DMP of the storage device 120 in the off state based on the estimated temperature SDTEMP of the storage device 120 and the data retention parameter DRP.

When the data management period DMP is reached, the data retention manager 114 may output the battery control signal BCS for supplying the power to the storage device 120 to the battery control device 131 and may output the data retention management signal RMS to the storage device 120.

The data retention manager 114 may include a temperature monitoring circuit 114a, a period determination circuit 114b, and a temperature offset monitoring circuit 114c.

The temperature monitoring circuit 114a may monitor the outside temperature OTEMP received through the communication interface 111 and may estimate the temperature SDTEMP of the storage device 120 based on the outside temperature OTEMP and the preset temperature offset TOS. The temperature monitoring circuit 114a may estimate the temperature SDTEMP of the storage device 120 by adding the outside temperature OTEMP and the preset temperature offset TOS.

The period determination circuit 114b may estimate the data management period DMP based on the estimated temperature SDTEMP of the storage device 120 and the data retention parameter DRP. The period determination circuit 114b may estimate the data management period DMP by applying the estimated temperature SDTEMP of the storage device 120 and the data retention parameter DRP to the Arrhenius equation. The period determination circuit 114b may also estimate the data management period DMP based on the exposure time table and the scale factor table.

The temperature offset monitoring circuit 114c may calculate a new temperature offset TOS based on the outside temperature OTEMP received during driving of the autonomous vehicle and the temperature SDTEMP of the storage device 120 received from the storage device 120 and may change the existing temperature offset TOS to the new temperature offset TOS.

The temperature offset monitoring circuit 114c may calculate the temperature offset TOS in consideration of environment conditions of the autonomous vehicle, such as the weather type WT, humidity, and a time, as well as the outside temperature OTEMP included in the weather information WI. The temperature offset monitoring circuit 114c may newly store the calculated temperature offset TOS and may update the existing temperature offset TOS. The temperature monitoring circuit 114a may estimate the temperature SDTEMP of the storage device 120 by using the newly stored temperature offset TOS or the updated temperature offset TOS.

The data retention manager 114 may be implemented in the form of software, hardware, or a combination thereof. When the data retention manager 114 is implemented in the form of software, information about the data retention manager 114 may be stored in the memory 113, and the data retention manager 114 stored in the memory 113 may be executed by the processor 112.

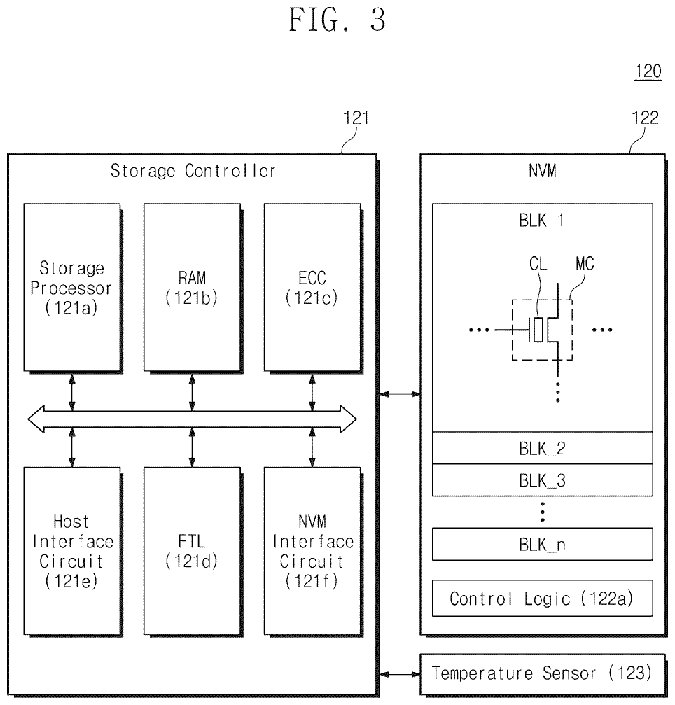

FIG. 3 is a block diagram illustrating an example storage device of FIG. 1. Referring to FIG. 3, the storage controller 121 includes a storage processor 121a, a random access memory (RAM) 121b, an error correction code (ECC) circuit 121c, a flash memory translation layer manager 121d, a host interface circuit 121e, and a nonvolatile memory interface circuit 121f.

The storage processor 121a included in the storage controller 121 may control an operation of the storage controller 121 in response to a command received from a host (e.g., an electronic device) through the host interface circuit 121e. For example, the storage processor 121a may control each component by using firmware for driving the storage device 120.

The RAM 121b included in the storage controller 121 may store an instruction executable by the storage processor 121a and data processed or to be processed by the storage processor 121a. For example, the RAM 121b may be implemented with a volatile memory device, which has a relatively small capacity and supports a fast speed, such as a static random access memory (SRAM) or a cache memory.

The ECC circuit 121c included in the storage controller 121 may perform ECC encoding and ECC decoding by using a BCH (Bose-Chaudhuri-Hocquenghem) code, an LDPC (Low Density Parity Check) code, a turbo code, a Reed-Solomon code, a convolution code, an RSC (Recursive Systematic Code), coded modulation, such as TCM (Trellis-Coded Modulation) or BCM (Block Coded Modulation), or any other error correction code.

The flash memory translation layer manager 121d included in the storage controller 121 may perform an address mapping operation. The address mapping operation refers to an operation of translating a logical address received from the host into a physical address to be used to actually store data in the nonvolatile memory device 122. The flash memory translation layer manager 121d may perform a wear-leveling operation for preventing the excessive degradation of memory blocks BLK_1, BLK_2, . . . , BLK_n, a garbage collection operation for securing an available capacity in the nonvolatile memory device 122, etc.

The host interface circuit 121e included in the storage controller 121 may provide the physical connection between the host and the storage device 120. That is, the host interface circuit 121e may provide an interface with the storage device 120 in compliance with the bus format of the host. In some implementations, the bus format of the host is the SCSI or SAS. In some implementations, the bus format of the host is universal serial bus (USB), peripheral component interconnect express (PCIe), ATA, PATA, SATA, NVMe, among other formats.

The nonvolatile memory interface circuit 121f included in the storage controller 121 may exchange data with the nonvolatile memory device 122. The nonvolatile memory interface circuit 121f may send data to the nonvolatile memory device 122 and may receive data read from the nonvolatile memory device 122.

The nonvolatile memory device 122 may include the plurality of memory blocks BLK_1, BLK_2, . . . , BLK_n and control logic 122a.

Each of the plurality of memory blocks BLK_1, BLK_2, . . . , BLK_n may include a plurality of pages including a plurality of memory cells MC, and each of the plurality of memory cells MC may store at least one bit depending on charges stored in a charge storage layer CL. The charge storage layer CL may be a conductive floating gate of a floating-gate structure or a trapping layer of a charge trap flash (CTF) structure. The memory cell MC may be programmed in various schemes such as a single level cell (SLC) scheme, a multi-level cell (MCL) scheme, a triple level cell (TLC) scheme, and a quadruple level cell (QLC) scheme.

The control logic 122a may be implemented to receive a command and an address from the storage controller 121 and to perform an operation (e.g., a program operation, a read operation, or an erase operation) corresponding to the received command with respect to memory cells MC corresponding to the received address.

The storage device 120 may further include a temperature sensor 123. The temperature sensor 123 senses a temperature of the nonvolatile memory device 122 so as to be sent to the storage controller 121. The temperature of the nonvolatile memory device 122 may correspond to a temperature of the storage device 120. The storage controller 121 may send data on the temperature sensed through the temperature sensor 123 to the electronic device 110. The temperature sensor 123 may be implemented in the nonvolatile memory device 122 in the form of an on-chip sensor or may be disposed outside the nonvolatile memory device 122. The temperature data collected through the temperature sensor 123 may be used to determine a temperature offset.

The storage controller 121 may receive a data retention management signal from the electronic device 110. In response to the data retention management signal, the storage controller 121 may allow the nonvolatile memory device 122 to perform a data management operation. When the storage device 120 performs the data management operation, the storage device 120 may control the nonvolatile memory device 122 to perform a scan operation of reading all the data stored in the nonvolatile memory device 122, a reclaim operation of moving valid data of a source memory block to a target memory block, and an operation, which is used to guarantee the reliability of data, such as a refresh operation of charging charges leaked out from the charge storage layer CL.

When a level of a bit error caused when the storage device 120 performs the data management operation is higher than the error correction capability of the ECC circuit 121c, the bit error may be uncorrectable; in this case, an error called an uncorrectable ECC (UECC) may occur.

A defense code may mean a software recovery algorithm. The defense code may be implemented by firmware in the solution. The defense code may correspond to various recovery algorithms for recovering data, including an operation of determining an optimized read level. When the UECC occurs, the storage device 120 enters the defense code. As the storage device 120 performs one or more defense code operations according to a set sequence, the storage device 120 may reduce the error or may allow the ECC circuit 121c to correct the error. The defense code may be classified as a fast recovery method at the expense of the accuracy or a method of performing recovery as accurately as possible through many operations. The defense code sequence may refer to the order of executing a plurality of defense codes. When the storage device 120 succeeds in error correction while performing the defense code operation based on the defense code sequence, the storage device 120 may end the recovery operation without executing the remaining defense codes.

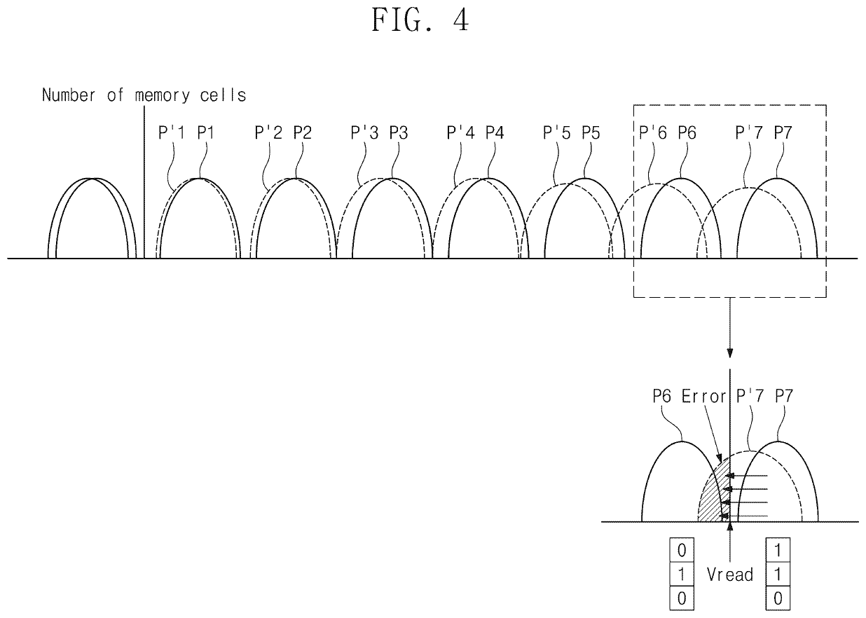

FIG. 4 is an example diagram for describing a threshold voltage change of memory cells caused in a storage device left alone for a long time in an off state.

Referring to FIG. 4, a threshold voltage distribution of memory cells included in the storage device 120 in the off state changes in a decreasing direction over time.

It is assumed that the memory cells are programmed in the TLC scheme. Threshold voltage distributions of memory cells are classified into P1 to P7 depending on program levels.

The charges stored in the charge storage layer of each memory cell may be leaked output depending on a temperature at which the storage device 120 is exposed and over time. In this case, the threshold voltage distributions P1 to P7 of the memory cells may change to threshold voltage distributions P1′ to P7′. When a threshold voltage of a memory cell is lower than a read voltage Vread set in advance, a data error may be caused.

In some implementations, the threshold voltage distribution P7 corresponds to 3-bit data of “110” and the threshold voltage distribution P6 corresponds to 3-bit data of “010”. That is, in the case of the threshold voltage distribution P7, the most significant bit is “1”, the central bit is “1”, and the least significant bit is “0”. In the case of the threshold voltage distribution P6, the most significant bit is “0”, the central bit is “1”, and the least significant bit is “0”.

In a memory cell that is programmed in the program operation such that a threshold voltage is greater than the read voltage Vread, the threshold voltage of the memory cell may be lower than the read voltage Vread due to the leakage of charges stored in the charge storage layer of the memory cell. In this case, the most significant bit may change from “1” to “0”. When a level of a bit error is a correctable level, the ECC circuit 121c of the storage device 120 may correct the bit error. However, when the level of the bit error exceeds the correctable level of the ECC circuit 121c due to the accumulation of the threshold voltage change, the data loss may occur in the storage device 120.

The electronic device 110 may determine a point in time to perform the data management operation based on an outside temperature and may control the battery system 130 to supply the power to the storage device 120.

The electronic device 110 may send the data management signal to the storage device 120 to which the power is supplied and may allow the storage device 120 to perform the data management operation such that the reliability of data stored in the storage device 120 is guaranteed. Accordingly, even though the autonomous vehicle is parked for a long time, the loss/corruption of data stored in the storage device 120 may be prevented.

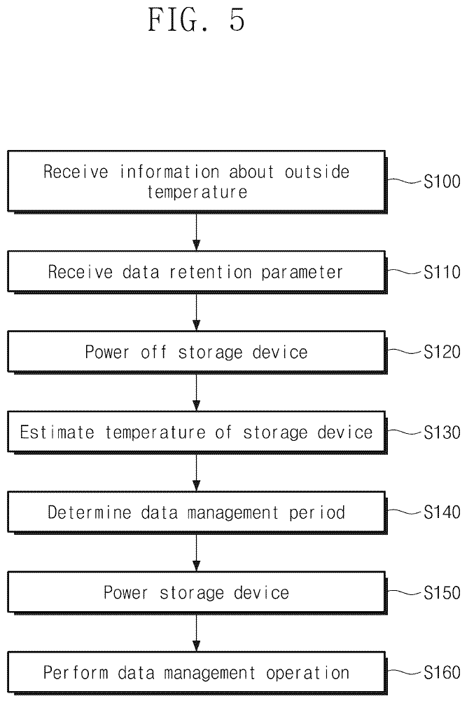

FIG. 5 is an example flowchart for describing an operation of an electronic system.

Referring to FIGS. 2 and 5, the electronic device 110 included in the electronic system 100 receives information about an outside temperature (S100). The electronic device 110 receives the weather information WI including the outside temperature OTEMP from the cloud server or the data center through the communication interface 111. The weather information WI includes data associated with various kinds of weather, in addition to the outside temperature OTEMP.

The electronic device 110 included in the electronic system 100 may receive a data retention parameter from the storage device 120 (S110). The data retention parameter refers to a value that is in advance set to indicate the data retention capability of the storage device 120. The data retention parameter that is a parameter associated with the data retention capability may include a data retention time and an acceleration constant according to a reference temperature.

The battery system 130 included in the electronic system 100 may block the power of the storage device 120 (S120). The storage device 120 may be powered off when the autonomous vehicle is parked.

The electronic device 110 included in the electronic system 100 may estimate a temperature of the storage device 120 (S130). The temperature of the storage device 120 may be estimated based on the outside temperature and the preset temperature offset. The electronic device 110 may estimate the temperature of the storage device 120 periodically (e.g., one hour/6 hours/24 hours).

The electronic device 110 included in the electronic system 100 may determine a data management period (S140). The data management period may be determined based on the estimated temperature of the storage device 120 and a data management parameter. The data management period may be determined further based on the exposure time table or the scale factor table.

The battery system 130 included in the electronic system 100 may supply the power to the storage device 120 in response to a battery control signal (S150).

The storage device 120 included in the electronic system 100 may perform the data management operation in response to the data retention management signal (S160). The data management operation may include at least one of the scan operation, the refresh operation, and the reclaim operation.

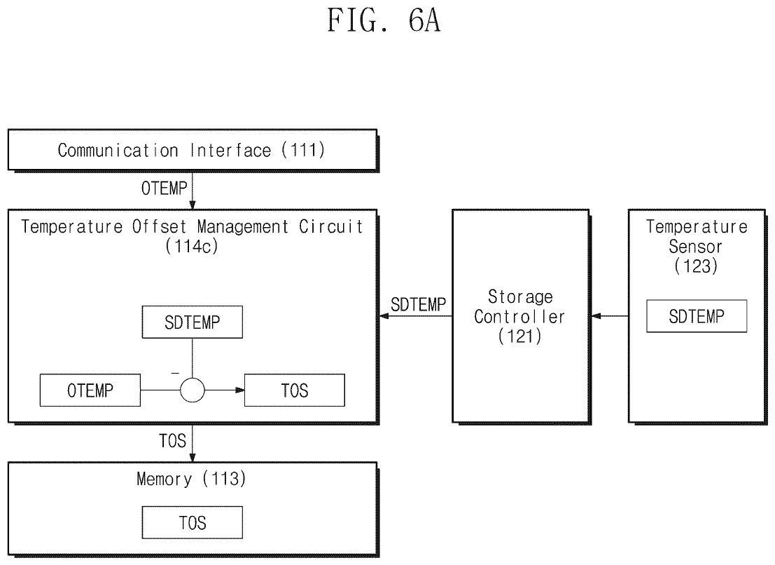

FIGS. 6A and 6B are diagrams for describing an example of an operation in which an electronic device estimates a temperature of a storage device.

Referring to FIG. 6A, the electronic device 110 calculates the temperature offset TOS based on a difference between the outside temperature OTEMP and the temperature SDTEMP of the storage device 120.

The temperature offset TOS may be updated by the temperature offset monitoring circuit 114c during driving of the autonomous vehicle. The temperature offset monitoring circuit 114c may receive the outside temperature OTEMP through the communication interface 111 and may receive the temperature SDTEMP of the storage device 120 through the temperature sensor 123 from the storage controller 121.

The temperature offset monitoring circuit 114c may calculate the temperature offset TOS based on a difference between the outside temperature OTEMP and the temperature SDTEMP of the storage device 120. The temperature offset monitoring circuit 114c may store the calculated temperature offset TOS in the memory 113. When the temperature offset TOS is already present in the memory 113, the existing temperature offset TOS may be changed to the new temperature offset TOS.

Referring to FIG. 6B, when the autonomous vehicle is parked, the temperature monitoring circuit 114a estimates the temperature SDTEMP of the storage device 120 based on the outside temperature OTEMP received through the communication interface 111 and the temperature offset TOS stored in the memory 113. While the autonomous vehicle is parked, the temperature monitoring circuit 114a may estimate the temperature SDTEMP of the storage device 120 based on a result of adding the received outside temperature OTEMP and the preset temperature offset TOS stored in the memory 113.

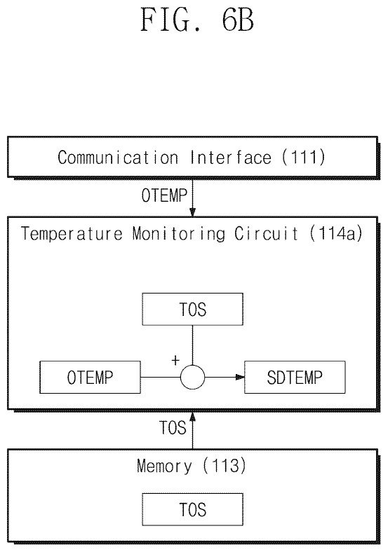

FIG. 7 is a diagram for describing another example of an operation in which an electronic device estimates a temperature of a storage device.

Referring to FIG. 7, the electronic device 110 estimates the temperature SDTEMP of the storage device 120 based on the outside temperature OTEMP and the weather type WT.

The electronic device 110 receives the weather information WI including the outside temperature OTEMP and the weather type WT and calculates a temperature offset for each weather type WT.

For example, it is assumed that a first weather type WT1 is included in weather information WI1 received from the outside. In this case, the electronic device 110 may calculate a temperature offset TOS_WT1 based on a difference between the temperature SDTEMP of the storage device 120 and an outside temperature OTEMPI in the environment of the first weather type WTI received from the outside. Likewise, the electronic device 110 may calculate a temperature offset TOS_WT2 corresponding to the environment of a second weather type WT2. The temperature offset TOS_WT1 corresponding to the first weather type WTI and the temperature offset TOS_WT2 corresponding to the second weather type WT2 may be updated to be respectively changed to the calculated values. The temperature offsets TOS_WT1 and TOS_WT2 may be updated depending on the temperature SDTEMP of the storage device 120 and the weather information WI1 and WI2 received during driving of the vehicle.

The electronic device 110 may receive weather information WI3 to estimate the temperature SDTEMP of the storage device 120. In this case, because a second weather type WT2 is included in the weather information WI3, the electronic device 110 may calculate the temperature SDTEMP of the storage device 120 by using the temperature offset TOS_WT2 updated in the environment of the second weather type WT2.

Meanwhile, the weather information WI may include various information such as humidity, rainfall, and snowfall, in addition to the outside temperature OTEMP and the weather type WT, and the temperature offset TOS may be updated based on various data included in the weather information WI. Also, the electronic device 110 may select the temperature offset TOS, which is used to estimate the temperature SDTEMP of the storage device 120, based on various data included in weather information.

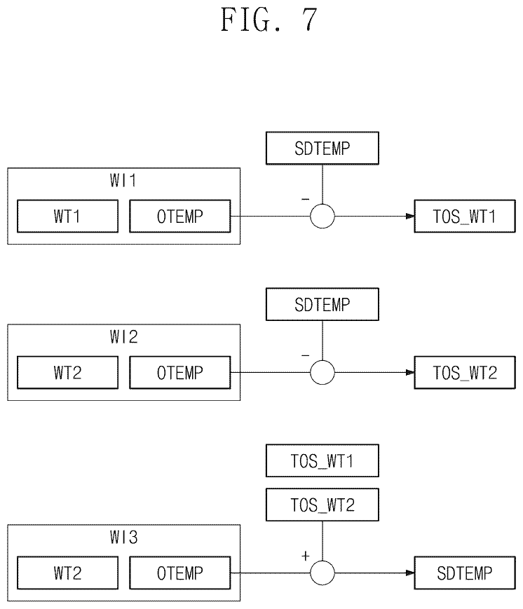

FIG. 8 is a graph illustrating an example of data retention time according to a temperature of a storage device. Referring to FIG. 8, a data retention time of the storage device 120 decreases/increases along a temperature at which the storage device 120 is exposed.

The data retention time may refer to a time that is necessary for the storage device 120 to retain data stably and may be defined as a time that is taken until data stored in the storage device 120 in the off state reaches a reference bit error rate. As a temperature of the storage device 120 increases, the probability that charges stored in the charge storage layer of the memory cell are leaked out may increase.

The reference temperature and the data retention time according to the reference temperature, which have values set to guarantee the reliability of data, may be determined depending on a characteristic and a purpose of the storage device 120. The data retention time under not only the reference temperature but also any other condition may have a value that is determined based on the Arrhenius equation defining a correlation of the reaction speed with the temperature and the activation energy. According to the Arrhenius equation, as the absolute temperature increases and as the activation energy decreases, the reaction speed increases. That is, the reaction amount increases during the same time. The reaction amount that is drawn by using the Arrhenius equation may correspond to the amount of leakage of charges stored in the charge storage layer of the memory cells included in the nonvolatile memory device 122, or a bit error rate caused by the leakage of charges.

In some implementations, the reference temperature of the storage device 120 may be 30° C., and the data retention time thereof may be 8760 hours. That is, the storage device 120 in the off state may guarantee the reliability of data during 8760 hours in an environment wherein the temperature of the storage device 120 is 30° C.

Meanwhile, in an environment where the temperature of the storage device 120 is 85° C., the storage device 120 may guarantee the reliability of data for about 59 hours. In an environment where the temperature of the storage device 120 is 100° C., the storage device 120 may guarantee the reliability of data for about 20 hours.

That is, the reaction amount for 8760 hours in the environment of 30° C., the reaction amount for 59 hours in the environment of 85° C., and the reaction amount for 20 hours in the environment of 100° C. may be regarded as identical. To guarantee the reliability of data, the storage device 120 should perform the data management operation before the data retention time passes.

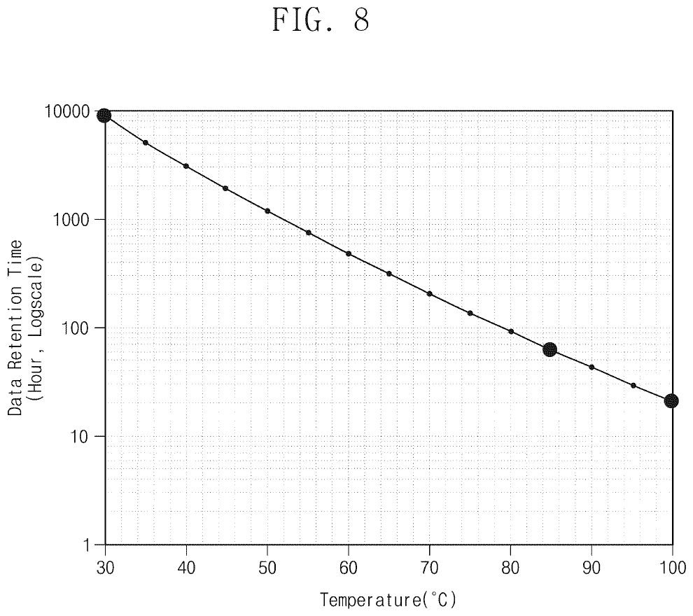

FIG. 9 is a diagram illustrating an example exposure time table. Referring to FIG. 9, the electronic device 110 determines a data management period based on an exposure time table ETT defined by a temperature TEMP and the data retention parameter DRP.

As described above, the data retention parameter DRP is determined depending on the characteristic and purpose of the storage device 120. In an environment where the data retention parameter DRP is DRP1 and the temperature SDTEMP of the storage device 120 is TEMP1, the data management period of the storage device 120 may be determined as exposure time ET11. The exposure time ET11 may be a value determined depending on the data retention time. In some implementations, the exposure time ET11 may be a time corresponding to a given ratio (e.g., 80%) of the data retention time. As the given ratio increases, the data management period may increase, and the reliability of data may decrease. As the given ratio decreases, the data management period may decrease, and the reliability of data may increase. To reinforce the reliability of data, a ratio of the data retention time and the exposure time may be set to be small; to make power consumption of the storage device 120 better, a ratio of the data retention time and the exposure time may be set to be great.

As the electronic device 110 determines the data management period by using the exposure time table ETT, without directly calculating the Arrhenius equation, the electronic device 110 may determine an appropriate data management period based on the data retention parameter DRP and the exposure temperature.

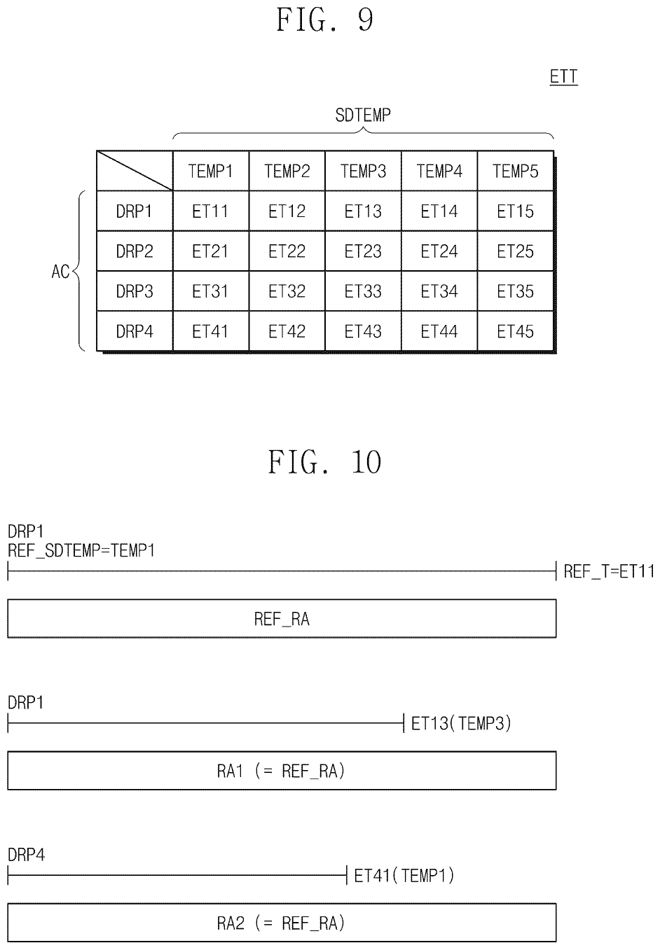

FIG. 10 is a diagram illustrating an example reaction amount according to an exposure time table of FIG. 9.

Referring to FIGS. 9 and 10, exposure times ET1 to ET45 of the exposure time table ETT correspond to the same reaction amount.

As described above, the reaction amount may correspond to the amount of leakage of charges stored in the charge storage layer of the memory cells included in the nonvolatile memory device 122, or the bit error rate caused by the leakage of charges. The reaction amount may be regarded as a parameter that is used to determine a data management period for guaranteeing the reliability of data stored in the storage device 120.

In some implementations, in the storage device 120 where the data retention parameter DRP is DRP1, when a reference temperature REF_SDTEMP of the storage device 120 is TEMP1 and a reference time REF_T is ET11, the reaction amount is a reference reaction amount REF_RA. The reference reaction amount REF_RA may be a threshold value that is used to determine the data management period. In this case, in an environment where the data retention parameter DRP is DRP1 and the temperature SDTEMP of the storage device 120 is TEMP1, the exposure time ET11 may be determined as the data management period.

In an environment where the data retention parameter DRP is DRP1 and the temperature SDTEMP of the storage device 120 is TEMP3, when TEMP3 corresponding to the temperature SDTEMP of the storage device 120 is higher than TEMP1 being the reference temperature REF_SDTEMP, the reaction speed corresponding to the temperature SDTEMP of the storage device 120 is higher than the reaction speed at the reference temperature REF_SDTEMP. Accordingly, the exposure time ET13 is smaller than the exposure time ET11. In this case, in an environment where the data retention parameter DRP is DRP1 and the temperature SDTEMP of the storage device 120 is TEMP3, a reaction amount RA1 during the exposure time ET13 is equal to the reference reaction amount REF_RA. In an environment where the data retention parameter DRP is DRP1 and the temperature SDTEMP of the storage device 120 is TEMP3, the electronic device 110 may determine the exposure time ET13 as the data management period.

In an environment where the data retention parameter DRP is DRP4 and the temperature SDTEMP of the storage device 120 is TEMP1, the temperature SDTEMP of the storage device 120 is equal to the reference temperature REF_SDTEMP, but the data retention parameters DRP are different, DPR1 and DPR4. The reaction speed in the environment where the data retention parameter DRP is DRP4 and the temperature SDTEMP of the storage device 120 is TEMP1 is higher than the reaction speed in the environment where the data retention parameter DRP is DRP1. Accordingly, the exposure time ET41 is smaller than the exposure time ET11. In an environment where the data retention parameter DRP is DRP4 and the temperature SDTEMP of the storage device 120 is TEMP1, a reaction amount RA2 during the exposure time ET41 is equal to the reference reaction amount REF_RA. In an environment where the data retention parameter DRP is DRP4 and the temperature SDTEMP of the storage device 120 is TEMP1, the electronic device 110 may determine the exposure time ET41 as the data management period.

When the data management period has elapsed from the time the storage device 120 is powered off, the electronic device 110 may send the battery control signal to the battery control device 131 such that the power is supplied to the storage device 120. Then, the electronic device 110 may send the data retention management signal to the storage device 120.

The storage device 120 may perform the data management operation in response to the data retention management signal. As described above, as the storage device 120 performs the data management operation depending on an optimized data management period in different environments, the storage device 120 may guarantee the reliability of data and may optimize power consumption.

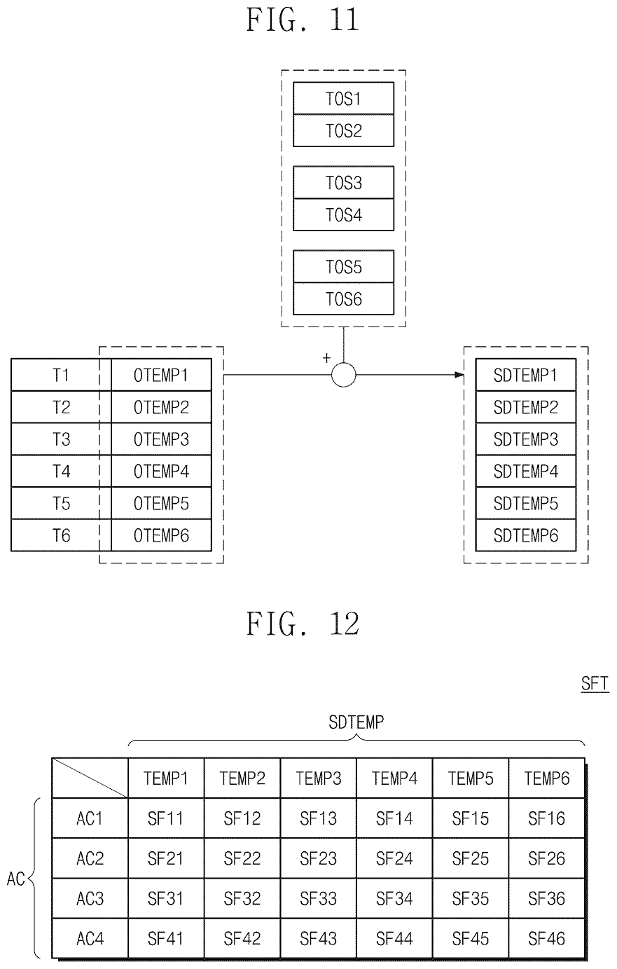

FIG. 11 is a diagram for describing an example of an operation in which an electronic device estimates a temperature of a storage device for each of a plurality of time periods. Referring to FIGS. 6B and 11, the electronic device 110 estimates temperatures SDTEMP1, SDTEMP2, . . . , SDTEMP6 of the storage device 120 in a plurality of time periods T1, T2, . . . , T6 based on outside temperatures OTEMP1, OTEMP2, . . . , OTEMP6 of the plurality of time periods T1, T2, . . . , T6. The electronic device 110 determines the data management period of the storage device 120 based on a temperature of the storage device 120 and a data retention parameter, for each of the plurality of time periods T1 to T6.

In addition to the outside temperature OTEMP associated with a time period including a specific point in time when the outside temperature OTEMP is received, the electronic device 110 may receive the outside temperature OTEMP associated with a time period after the specific point in time and the outside temperature OTEMP associated with a time period before the specific point in time. The outside temperature OTEMP associated with the time period before the specific point in time may be a previously measured outside temperature OTEMP, and the outside temperature OTEMP associated with the time period after the specific point in time may be the outside temperature OTEMP corresponding to a weather forecast.

The electronic device 110 may estimate the temperatures SDTEMP1 to SDTEMP6 of the storage device 120 in the plurality of time periods T1 to T6 based on the outside temperatures OTEMP1 to OTEMP6 in the plurality of time periods T1 to T6 and the temperature offset TOS. In this case, a plurality of temperature offsets TOS1, TOS2, . . . , TOS6 may be used.

In some implementations, each of the temperature offsets TOS1 to TOS6 may be a value set depending on the outside temperature OTEMP. The outside temperature OTEMP1 may correspond to the temperature offset TOS1, and the temperature SDTEMP1 of the storage device 120 may be estimated based on a result of adding the outside temperature OTEMP1 and the temperature offset TOS1. The outside temperature OTEMP2 may correspond to the temperature offset TOS2, and the temperature SDTEMP2 of the storage device 120 may be estimated based on a result of adding the outside temperature OTEMP2 and the temperature offset TOS2.

In another example, each of the temperature offsets TOS1 to TOS6 may be a value set depending on a time period. The time period T3 may correspond to the temperature offset TOS3, and the temperature SDTEMP3 of the storage device 120 may be estimated based on a result of adding the outside temperature OTEMP3 and the temperature offset TOS3. The time period T4 may correspond to the temperature offset TOS4, and the temperature SDTEMP4 of the storage device 120 may be estimated based on a result of adding the outside temperature OTEMP4 and the temperature offset TOS4.

In another example, each of the temperature offsets TOS1 to TOS6 may be a value set depending on any other data included in weather information. For example, the temperature offset TOS5 may correspond to “clear” being one of weather types, and the temperature SDTEMP5 of the storage device 120 may be estimated based on a result of adding the outside temperature OTEMP5 and the temperature offset TOS5. As another example, the temperature offset TOS6 may correspond to “cloudy” being one of weather types, and the temperature SDTEMP6 of the storage device 120 may be estimated based on a result of adding the outside temperature OTEMP6 and the temperature offset TOS6.

The above description about the temperature offsets TOS1 to TOS6 is given as an example, and the temperature offsets TOS1 to TOS6 may be set and applied in various schemes for accurately estimating the temperature SDTEMP of the storage device 120 through the outside temperature OTEMP.

FIG. 12 is a diagram illustrating an example scale factor table. Referring to FIG. 12, the electronic device 110 determines the data management period further based on a scale factor table SFT defined based on the temperature SDTEMP of the storage device 120 and an acceleration constant AC.

Each of scale factors SF11 to SF46 is a value indicating a relative ratio of a reaction amount per time according to the temperature SDTEMP of the storage device 120 and the acceleration constant AC. The scale factors SF11 to SF46 may be defined based on the Arrhenius equation.

The reaction amount during the same time may vary depending on the temperature SDTEMP of the storage device 120 and the acceleration constant AC. According to the Arrhenius equation, as the reaction temperature increases, the reaction speed may increase. This may mean that the reaction amount during the same time increase.

Under the condition of an acceleration constant AC1, during the same time, the reaction amount when the temperature SDTEMP of the storage device 120 is TEMP1 is smaller than the reaction amount when the temperature SDTEMP of the storage device 120 is TEMP4. Accordingly, the scale factor SF11 indicating the relative ratio of the reaction amount per time is smaller than the scale factor SF14.

Meanwhile, the scale factors SF11 to SF46 may change depending on the acceleration constant AC. The acceleration constant AC corresponds to the activation energy of the Arrhenius equation, and as the acceleration energy decreases, the reaction speed increases. Accordingly, in a situation where the temperature SDTEMP of the storage device 120 is TEMP1, when an acceleration constant AC2 is greater than the acceleration constant AC1, the reaction speed at the acceleration constant AC2 may be lower than the reaction speed at the acceleration constant AC1, and thus, the scale factor SF12 may be smaller in value than the scale factor SF11.

The scale factor table SFT may include the scale factors SF11 to SF46, each of which is determined based on the acceleration constant AC and the temperature SDTEMP of the storage device 120, and the electronic device 110 may easily draw the amount of total reaction by using the scale factors SF11, SF12, . . . , SF46 included in the scale factor table SFT. The electronic device 110 may calculate the reaction amount for each of a plurality of time periods, and may determine a time taken to reach a threshold value of the amount of total reaction, that is, the data management period.

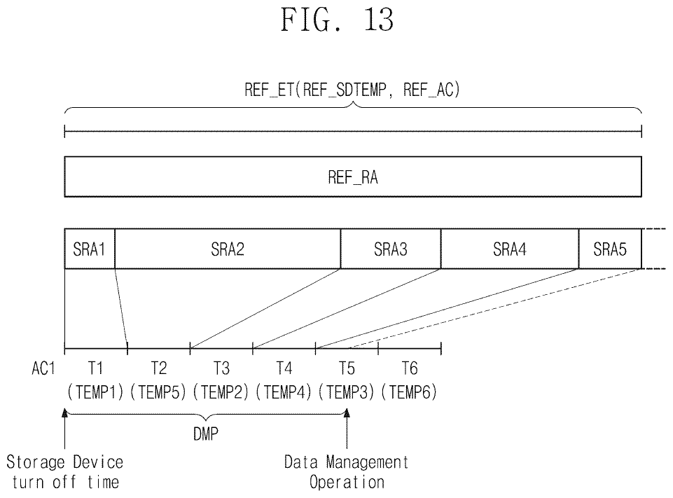

FIG. 13 is a diagram for describing an example of an operation in which an electronic device determines a data management period based on a temperature of a storage device for each of a plurality of time periods. Referring to FIG. 13, the electronic device 110 determines the data management period based on the threshold voltage of the reaction amount.

It is assumed that the data management operation of the storage device 120 is required at a reference exposure time REF_ET, when the temperature SDTEMP of the storage device 120 is the reference temperature REF_SDTEMP and the acceleration constant is a reference acceleration constant REF_AC. That is, the reference exposure time REF_ET may be a time corresponding to a given ratio of the data retention time. In this case, the reaction amount may be referred to as the “reference reaction amount REF RA”.

That is, in the storage device 120 of the off state, when charges of memory cells are leaked out as much as the reference reaction amount REF_RA or it reaches a bit error rate, the storage device 120 need perform the data management operation.

The electronic device 110 may calculate the total reaction amounts in the plurality of time periods T1 to T6 according to the storage temperatures SDTEMP1 to SDTEMP6 in the plurality of time periods T1 to T6.

The storage device 120 may have the acceleration constant AC1, and the reaction amount is SRA1 in an environment wherein the temperature SDTEMP of the storage device 120 estimated during the time period T1 is TEMP1. The reaction amount is SRA2 in an environment wherein the temperature SDTEMP of the storage device 120 estimated during the time period T2 is TEMP5. That is, the reaction amount in the time periods T1 and T2 corresponds to a sum of SRA1 and SRA2.

The reaction amount in the time periods T1 to T4 corresponds to a sum of SRA1 to SRA4. In this case, the sum of SRA1 to SRA4 is smaller than the reference reaction amount REF_RA.

Meanwhile, the reaction amount in the time periods T1 to T5 is a sum of SRA1 to SRA5. In this case, the sum of SRA1 to SRA5 is greater than the reference reaction amount REF_RA. Accordingly, the total reaction amount until the time period T4 passes is smaller than the reference reaction amount REF_RA, and the total reaction amount until the time period T5 passes is greater than the reference reaction amount REF_RA. The electronic device 110 may determine the data management period DMP after the time period T4 passes and before the time period T5 passes.

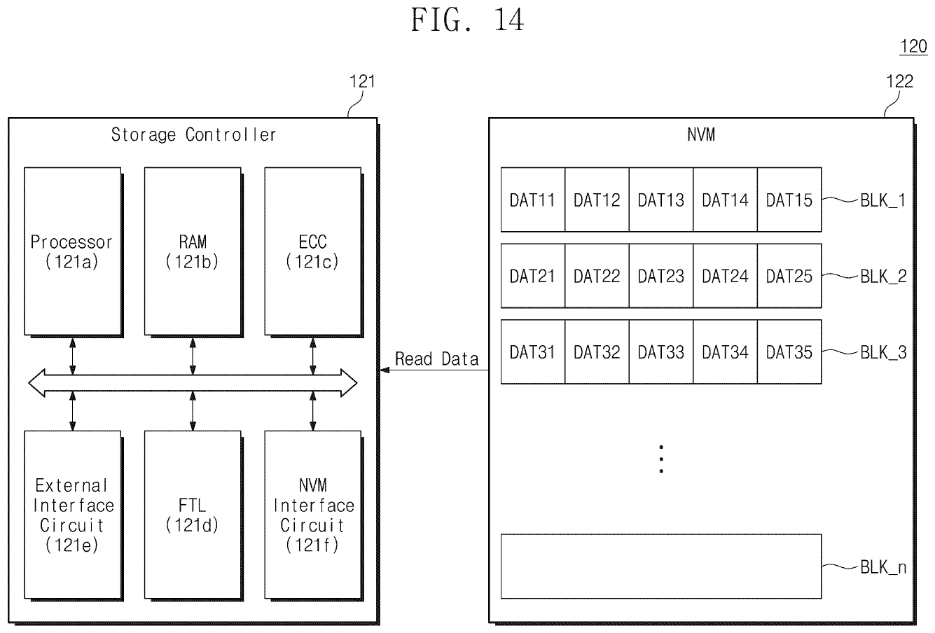

The reaction amount SRA1 may be determined based on the scale factors SF11 to SF46 described with reference to FIG. 14. Each of the scale factors SF11 to SF46 indicates a relative value of a reaction amount per time according to the acceleration constant AC and the temperature SDTEMP of the storage device 120. Accordingly, the reaction amount SRA1 may be calculated based on the scale factor SF11 corresponding to the acceleration constant AC1 and the temperature TEMP1. The reaction amount SRA2 may be calculated based on the scale factor SF15 corresponding to the acceleration constant AC1 and the temperature TEMP5.

The electronic device may control the battery system to power the storage device 120 after the data management period DMP has elapsed from the time the storage device is powered off and may send the data retention management signal to the storage device 120 such hat the storage device 120 performs the data management operation. The electronic device 110 may retain the data stored in the storage device 120. Accordingly, the reliability of data stored in the storage device 120 may be guaranteed.

FIG. 14 is a diagram for describing an example of a data management operation that a storage device performs. Referring to FIG. 14, the storage device 120 performs the scan operation when performing the data management operation.

Data DAT11, data DAT12, data DAT13, data DAT14, and data DAT15 may be stored in the memory block BLK_1 of the nonvolatile memory device 122. The storage controller 121 may read the data DAT11 to the data DAT15 stored in the memory block BLK_1. After reading the data stored in the memory block BLK_1, the storage controller 121 may read data DAT21 to data DAT25 stored in the memory block BLK_2. The storage controller 121 may read all the data of the nonvolatile memory device 122, that is, all the data stored in the memory blocks BLK_1 to BLK_n.

The storage controller 121 may check an error present in the read/stored data through the ECC circuit 121c while performing the scan operation. The UECC may occur when the bit error included the read data read from the nonvolatile memory device 122 is incapable of being corrected by the ECC circuit 121c (or when the level of the bit error exceeds the error correction capability of the ECC circuit 121c).

The storage controller 121 may check the reliability of data stored in the nonvolatile memory device 122 through the scan operation of reading all the data stored in the nonvolatile memory device 122. That is, the storage controller 121 may check the error level of the nonvolatile memory device 122 through the scan operation. The storage controller 121 may take subsequent actions based on the error level checked through the scan operation. For example, when an error is correctable through the ECC circuit 121c, the refresh or reclaim operation may be performed. When the UECC occurs in the data stored in the nonvolatile memory device 122, the storage controller 121 may perform the data recovery operation for recovering the UECC.

Meanwhile, the scan operation that the storage controller 121 performs may be referred to as a “patrol read operation”.

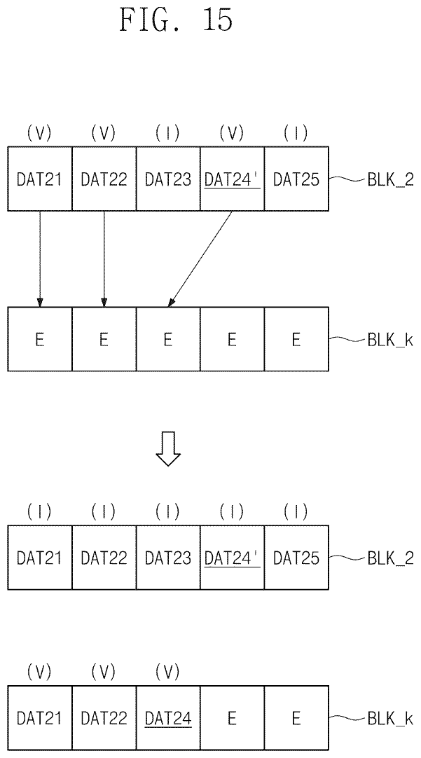

FIG. 15 is a diagram for describing another example of a data management operation that a storage device performs. Referring to FIG. 15, the storage device 120 performs the reclaim operation when performing the data management operation.

The reclaim operation accompanies an operation of writing data stored in a memory block of the nonvolatile memory device 122 in any other memory block of the nonvolatile memory device 122.

Referring to the memory block BLK_2 and the memory block BLK_k among the plurality of memory blocks BLK_1 to BLK_n included in the nonvolatile memory device 122, data may be written in the entire space of the memory block BLK_2, and the memory block BLK_k may be a free memory block being in a state where the entire space of the memory block BLK_k is empty (or erased). Data DAT21, data DAT22, and DAT24′ stored in the memory block BLK_2 are valid data “V”, and data DAT23 and data DAT25 are invalid data “I”. The data DAT24′ are data where there occurs a bit error whose level is within the error correction capability of the ECC circuit 121c.

When performing the read operation on the data stored in the memory block BLK_2, the storage controller 121 may correct the error occurring in the data DAT24′ through the ECC circuit 121c. In this case, the ECC circuit 121c may generate data DATA24 being the corrected data that are obtained by correcting the error of the data DAT24′.

The storage controller 121 may write the data DAT21, the data DAT22, and the corrected data DAT24 in the space of the memory block BLK_k. The storage controller 121 may mark the data DAT21, the data DAT22, and the data DAT24′ present in the memory block BLK_2 as the invalid data “I”.

In this case, the data DAT21 to the data DAT25 present in the memory block BLK_2 correspond to the invalid data “I”, and the data DAT21, the data DAT22, and the data DAT24 present in the memory block BLK_k correspond to error-corrected data as valid data.

The flash memory translation layer manager 121d of the storage controller 121 may update the mapping of physical addresses and the logical addresses. That is, logical addresses of the data DAT21, DAT22, and DAT24 may be mapped to physical addresses corresponding to the memory block BLK_k.

All the data present in the memory block BLK_2 may be invalid, and the memory block BLK_2 may be in a state where the entire space of the memory block BLK_2 are full. Afterwards, the memory block BLK_2 may return to the free memory block through the erase operation.

Through the reclaim operation, the storage device 120 may correct a correctable error of data by using the ECC circuit 121c and may write the error-corrected data in a new memory block, and thus, a bit error may be prevented from being accumulated in the storage device 120. In other words, the UECC occurring due to the accumulated bit error may be prevented. Accordingly, the reliability of data stored in the storage device 120 may be guaranteed.

Meanwhile, the reclaim operation that the storage device 120 performs may be also referred to as a “remapping-based refresh operation”.

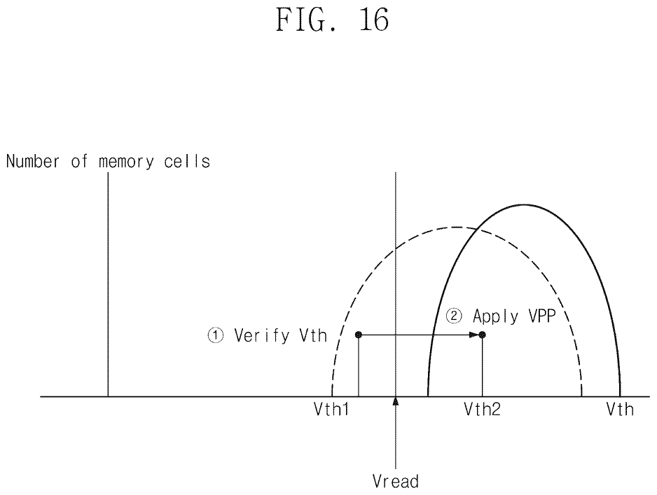

FIG. 16 is a diagram for describing another example of a data management operation that a storage device performs. Referring to FIG. 16, the storage device 120 performs the refresh operation when performing the data management operation.

As described above, a main cause of a data retention error occurring in the storage device 120 of the off state is the leakage of charges stored in the charge storage layer of the memory cell. Accordingly, due to the leakage, a threshold voltage of a programmed memory cell may move in a decreasing direction.

Meanwhile, the stored data may be erased in units of memory block, and the in-place overwrite operation is not permitted due to the characteristic of the nonvolatile memory device 122, in which data are capable of being written only in a space of an erase state. However, a program voltage pulse VPP may be applied in units of memory cell.

The storage controller 121 may read data stored in the nonvolatile memory device 122 to check the reliability of data. The ECC circuit 121c of the storage controller 121 may check whether a bit error occurs in the data read from the nonvolatile memory device 122 and may correct the bit error within the error correction capability of the ECC circuit 121c. The storage controller 121 may send the data corrected by the ECC circuit 121c to the nonvolatile memory device 122.

The control logic 122a of the nonvolatile memory device 122 may verify the threshold voltage of the memory cell where the bit error occurs (\textcircled{1}). That is, the control logic 122a may check whether the threshold voltage of the memory cell is lower than the read voltage Vread. To check whether the threshold voltage of the memory cell is lower than the read voltage Vread, the control logic 122a may use the corrected data received from the storage controller 121.

The control logic 122a of the nonvolatile memory device 122 may apply the program voltage pulse VPP to the memory cell where the bit error occurs (\textcircled{2}). Charges that are leaked out from the charge storage layer of the memory cell may be charged in the charge storage layer by the program voltage pulse VPP applied to the memory cell where the bit error occurs. Accordingly, the threshold voltage of the memory cell may be increased from a voltage Vth 1 lower than the read voltage Vread to a voltage Vth2 higher than the read voltage Vread.

In the case of verifying the threshold voltage of the memory cell where the bit error occurs, when it is determined that the threshold voltage is higher than the read voltage Vread, the control logic 122a of the nonvolatile memory device 122 may stop the refresh operation and may not apply the program voltage pulse VPP. When the refresh operation is limited, the bit error may be solved through the refresh operation described above.

Through the refresh operation, the storage device 120 may correct a correctable error through the ECC circuit 121c and may apply the program voltage pulse VPP to compensate for a decreased threshold voltage, and thus, the storage device 120 may charge the leaked charges in the charge storage layer and may increase the threshold voltage. According to the above description, the bit error may be prevented from being accumulated in the storage device 120. In other words, the UECC occurring due to the accumulated bit error may be prevented. Accordingly, the reliability of data stored in the storage device 120 may be guaranteed.

The refresh operation that the storage device 120 performs may be also referred to as an “in-place refresh operation”.

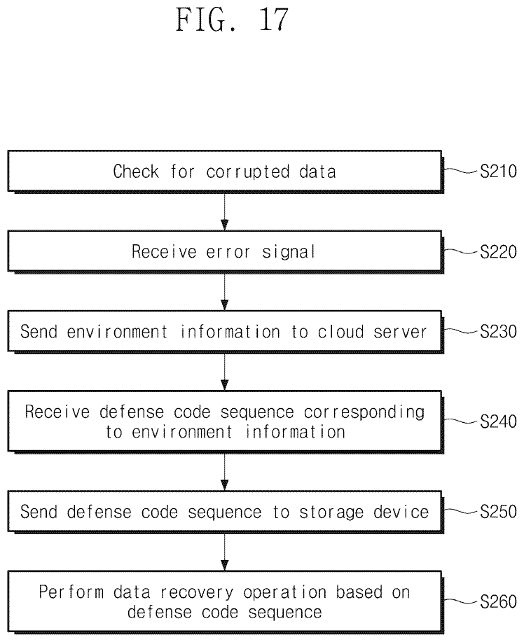

FIG. 17 is a flowchart for describing an example of a data recovery operation that a storage device performs. Referring to FIG. 17, the storage device 120 checks the corrupted data while performing the data management operation (S210). The corrupted data means data in which the UECC occurs due to a bit error level exceeding the error correction capability of the ECC circuit 121c. The storage device 120 sends an error signal to the electronic device 110 in response to the corrupted data.

The electronic device 110 receives the error signal from the storage device 120 (S220).

The electronic device 110 sends environment information to the cloud server in response to the error signal from the storage device 120 (S230). The environment information may include information about the exposure temperature and the exposure time of the storage device 120. The cloud server may retrieve a defense code sequence corresponding to the environmental information received from the electronic device 110. The defense code sequence corresponding to the environmental information may be an optimized defense code sequence, which relates to an execution order of the defense code that is successful in recovering data in an environment similar to the environmental information received from the electronic device 110. The cloud server may send the defense code sequence to the electronic device 110.

The electronic device 110 receives the defense code sequence corresponding to the environment information from the cloud server (S240).

The electronic device 110 sends the defense code sequence to the storage device 120 (S250).

The storage device 120 performs the data recovery operation on the corrupted data depending on the received defense code sequence (S260). Because the preset defense code sequence of the storage device 120 fails to know the error level of the corrupted data accurately, a defense code associated with the quick recovery method at the expense of the accuracy may be first executed; when the data recovery operation fails, a defense code associated with the method of performing recovery as accurately as possible through many operations may be executed.

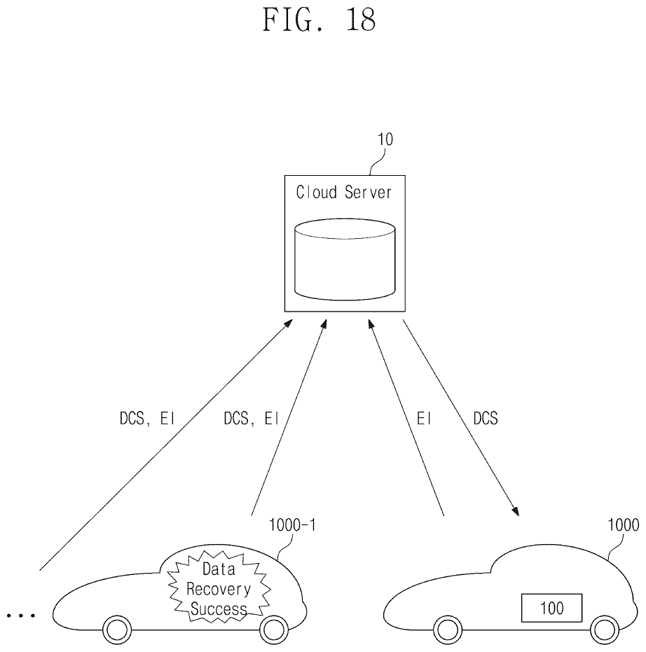

FIG. 18 is a diagram for describing an example of an operation in which an electronic device receives a defense code sequence. Referring to FIGS. 1, 17, and 18, the electronic device 110 included in the electronic system 100 mounted in an autonomous vehicle 1000 sends environment information EI of the storage device 120 to a cloud server 10 in response to an error signal corresponding to corrupted data of the storage device 120.

The cloud server 10 may receive a defense code sequence DCS by which data recovery succeeds and environment information about an environment where a storage device of any other vehicle 1000-1 is exposed, from the vehicle 1000-1. The cloud server 10 may store the defense code sequence DCS optimized for the environment information EI, based on the defense code sequence DCS and the environment information EI received from the vehicle 1000-1.

The electronic device 110 may receive, from the cloud server 10, the defense code sequence DCS corresponding to the environment information EI sent to the cloud server 10. The defense code sequence DCS received from the cloud server 10 corresponds to the defense code sequence DCS optimized based on defense code sequences collected from a plurality of vehicle including the vehicle 1000-1.

The storage device 120 included in the electronic system 100 may perform the data recovery operation of recovering the corrupted data based on the optimized defense code sequence DCS received from the cloud server 10, and thus, the computation and time necessary for data recovery may be saved.

Meanwhile, when the storage device 120 succeeds in data recovery, the electronic device 110 may send the environment information EI and the defense code sequence DCS succeeding in data recovery to the cloud server 10. The cloud server 10 may update the optimized defense code sequence DCS based on the environment information EI and the defense code sequence DCS received from the autonomous vehicle 1000.

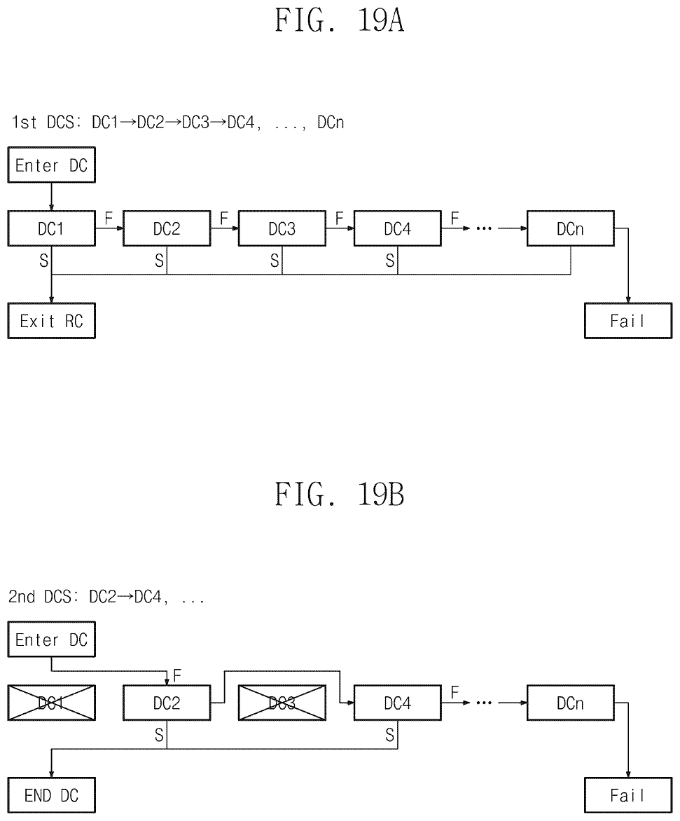

FIGS. 19A and 19B are diagrams for describing an example of a defense code that an electronic device executes. Referring to FIG. 19A, the storage device 120 enters a defense code DC to perform the data recovery operation on the corrupted data.

A first defense code sequence 1st DCS of the storage device 120 that is set in advance provides the following execution order: a first defense code DC1, a second defense code DC2, a third defense code DC3, a fourth defense code DC4, . . . , an n-th defense code DCn.

According to the first defense code sequence 1st DCS, for the data recovery time and the efficiency of resources used in data recovery, defense codes that make it possible to perform data recovery quickly at the expense of the accuracy may be first executed, and defense codes that make it possible to perform data recovery as accurately as possible through many operations may be then executed.

When the storage device 120 succeeds in the recovery of the corrupted data through the execution of a defense code, the storage device 120 may end the defense code. When the storage device 120 fails in the recovery of the corrupted data through the execution of a defense code, the storage device 120 may execute a next defense code according to the defense code sequence DCS.

In some implementations, after entering a defense code, the storage device 120 may execute the first defense code DC1. When the storage device 120 succeeds in the recovery of the corrupted data(S), the storage device 120 may end the defense code without executing the remaining defense codes DC2 to DCn. When the storage device 120 fails in the recovery of the corrupted data (F) through the execution of the first defense code DC1, the storage device 120 may execute the second defense code DC2.

When the storage device 120 fails in the recovery of the corrupted data (F) through the execution of the n-th defense code DCn being the last defense code of the first defense code sequence 1st DCS, the storage device 120 may determine that the data recovery fails; in this case, the storage device 120 may notify the electronic device 110 that uncorrectable data occur.

The case where the data recovery succeeds through the execution of the fourth defense code DC4 means that the data recovery using the first defense code DC1 to the third defense code DC3 fails. When the storage device 120 directly executes the fourth defense code DC4 without executing the first defense code DC1 to the third defense code DC3, the computation and time necessary to execute the first defense code DC1 to the third defense code DC3 may be reduced. However, because the storage device 120 fails to know a data corruption level, the storage device 120 sequentially executes the first defense code DC1 to the third defense code DC3.

FIG. 19B shows how to perform the data recovery operation based on a second defense code sequence 2nd DCS received from the cloud server 10.

The second defense code sequence 2nd DCS received from the cloud server 10 may perform the remaining defense codes other than a specific defense code(s) of the first defense code sequence 1st DCS set in advance.

For example, the first defense code sequence 1st DCS set in advance may provide the following execution order: the first defense code 1 DC1, the second defense code DC2, the third defense code DC3, the fourth defense code DC4, . . . , the n-th defense code DCn; however, according to the second defense code sequence 2nd DCS received from the cloud server 10, the first defense codel DC1 and the third defense code DC3 may not be executed. After entering a defense code, the storage device 120 may execute the second defense code DC2. When the storage device 120 succeeds in the recovery of the corrupted data through the execution of the second defense code DC2, the storage device 120 may end the defense code. When the storage device 120 fails in the recovery of the corrupted data through the execution of the second defense code DC2, the storage device 120 may execute the fourth defense code DC4.

The defense code execution order that the second defense code sequence 2nd DCS provides may be changed. For example, as illustrated in FIG. 19B, first, defense code DC2 may be performed; when defense code DC2 fails, defense code DC4 may be performed. However, defense code DC2 may be performed after defense code DC4 is performed.

The cloud server 10 may provide the storage device 120 with a defense code sequence succeeding in a vehicle of a like environment, and the storage device 120 may perform the data recovery operation based on the defense code sequence succeeding in the vehicle of the like environment. The storage device 120 may execute a defense code depending on an optimized defense code sequence, and thus, the computation and time necessary for the execution of the defense code may be reduced.

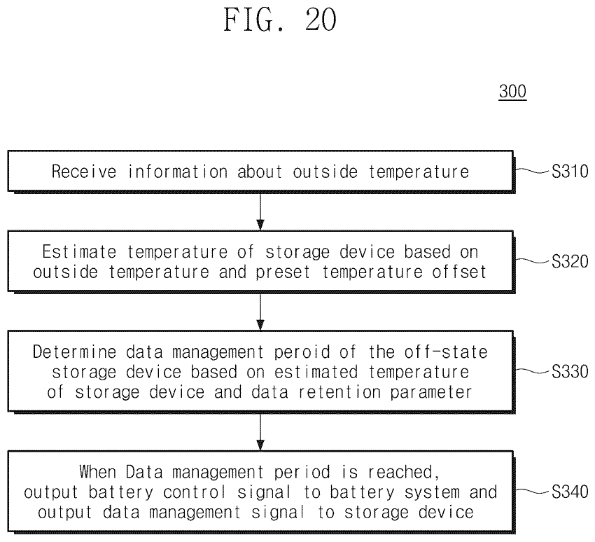

FIG. 20 is a flowchart illustrating an example operating method of an electronic device. Referring to FIG. 20, an operating method 300 of the electronic device 110 includes receiving an outside temperature (S310). Operation S310 may be performed through the communication interface 111 and the data retention manager 114 included in the electronic device 110.

The operating method 300 of the electronic device 110 includes estimating a temperature of a storage device based on the outside temperature and a preset temperature offset (S320). Operation S320 may be performed by the temperature monitoring circuit 114a included in the data retention manager 114 of the electronic device 110.

The operating method 300 of the electronic device 110 includes determining a data management period of the storage device in the off state based on the estimated temperature of the storage device and a data retention parameter (S330).

When the data management period is reached, the operating method 300 of the electronic device 110 includes outputting a battery control signal to a battery system and outputting a data management signal to the storage device (S340). Operation S340 may be performed by the data retention manager 114 included in the electronic device 110.

Meanwhile, the operating method 300 of the electronic device 110 may further include receiving an error signal corresponding to corrupted data of the storage device, sending environment information of the storage device to a cloud server in response to the error signal, receiving a defense code sequence from the cloud server, and sending the defense code sequence to the storage device.

The operating method 300 of the electronic device 110 may further include receiving an outside temperature and a temperature of the storage device during driving of the vehicle and updating the temperature offset based on the outside temperature and the temperature of the storage device received during driving of the vehicle.

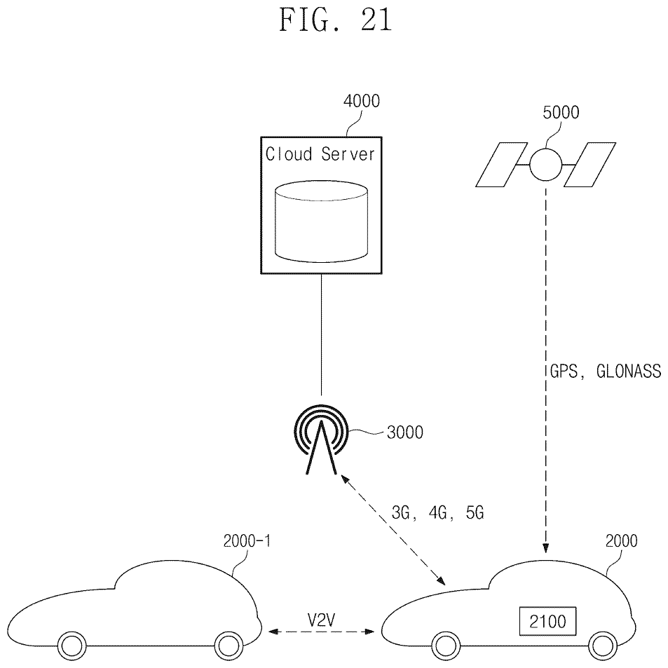

FIG. 21 is an example diagram illustrating communication of an electronic device installed in an autonomous vehicle. Referring to FIG. 21, an autonomous vehicle 2000 communicates with the outside of the autonomous vehicle 2000 through an electronic device 2100.

The electronic device 2100 may communicate with any other vehicle 2000-1 through the vehicle to vehicle (V2V) communication.

Through the vehicle to network (V2N) supported by a wireless communication scheme such as 5G communication, long term evolution (LTE), or 3G communication, the electronic device 2100 may communicate with a base station 3000 and may send/receive data to/from a cloud server 4000.

The electronic device 2100 may receive GPS, GLONASS, Galileo, BDS, IRNSS, and QZSS navigation signals from navigation satellite 5000 and may identify a position of the autonomous vehicle 2000.

In some implementations, an electronic device installed in an autonomous vehicle, an electronic system including the same, and an operating method thereof may make it possible to reduce power consumption of a storage device and to improve the reliability of data.

When the autonomous vehicle is parked, the storage device may be left alone for a long time, with a power turned off; in this case, data stored in the storage device may be corrupted. In other words, it may be impossible to guarantee the reliability of data stored in the storage device. When the power is supplied to the storage device to guarantee the reliability of data stored in the storage device, the power may be consumed in the storage device, thereby causing the waste of battery energy of the autonomous vehicle.

An electronic device, an electronic system including the same, and an operating method thereof may estimate a temperature of a storage device, which is in a state of being powered off, based on an outside temperature received from the outside of an autonomous vehicle and may determine the timing to perform a data management operation based on the estimated temperature of the storage device. As the storage device is supplied with the power at the timing to perform the data management operation and performs the data management operation, the storage device may minimize power consumption and may improve the reliability of data stored therein.

An electronic device, an electronic system including the same, and an operating method thereof may estimate a temperature of a storage device in an off state based on an outside temperature of a vehicle and may determine a timing to perform a data management operation such that the storage device secures the reliability of data, and thus, the reliability of data may be improved.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. An electronic device installed in a vehicle, comprising:
a communication interface; and
a data retention circuit configured to communicate through the communication interface,
wherein the data retention circuit is configured to:
estimate a temperature of a storage device based on information about an outside temperature received through the communication interface and a preset temperature offset, wherein the outside temperature is a temperature outside of the vehicle; and
determine a data management period of the storage device in an off state based on the temperature of the storage device that is estimated by the data retention circuit and on a data retention parameter.

2. The electronic device of claim 1, wherein, when the data management period is reached, the data retention circuit is configured to output a battery control signal to a battery control device, which is configured to supply a power to the storage device in the off state, and to output a data retention management signal to the storage device.

3. The electronic device of claim 1, wherein the data retention circuit is configured to determine the data management period further based on an exposure time table of the temperature of the storage device and the data retention parameter.

4. The electronic device of claim 3, wherein for each time period of a plurality of time periods, the outside temperature corresponds to a temperature outside of the vehicle for that time period,
wherein the data retention circuit is configured to:
estimate a temperature of the storage device in each time period of the plurality of time periods based on the outside temperature of each time period of the plurality of time periods; and
determine the data management period of the storage device in the off state based on the estimated temperature of the storage device in each time period of the plurality of time periods and the data retention parameter.

5. The electronic device of claim 4, wherein the data retention parameter includes a data retention time and an acceleration constant according to a reference temperature.

6. The electronic device of claim 5, wherein the data retention circuit is configured to determine the data management period further based on a scale factor table of the temperature of the storage device and the acceleration constant.

7. The electronic device of claim 1, wherein the data retention circuit is configured to:
send environment information of the storage device to a cloud server through the communication interface in response to an error signal corresponding to corrupted data of the storage device;
receive a defense code sequence corresponding to the environment information from the cloud server; and
send the received defense code sequence to the storage device.

8. The electronic device of claim 7, wherein the environment information includes an exposure temperature and an exposure time of the storage device.

9. The electronic device of claim 1, wherein the data retention circuit is configured to update the temperature offset based on the temperature of the storage device and an outside temperature outside of the vehicle and received during driving of the vehicle.

10. The electronic device of claim 9, wherein the data retention circuit is further configured to receive information about a weather type, and
wherein the temperature offset is determined based on the outside temperature, the weather type, and the temperature of the storage device.

11. An electronic system comprising:
an electronic device installed in a vehicle;
a battery system; and
a storage device,
wherein the electronic device is configured to:
estimate a temperature of the storage device based on received information about an outside temperature and a preset temperature offset, wherein the outside temperature is a temperature outside of the vehicle;
determine a data management period of the storage device in an off state based on the temperature of the storage device estimated by the electronic system and on a data retention parameter; and
when the data management period is reached, output a battery control signal to the battery system for supplying a power to the storage device in the off-state and output a data retention management signal to the storage device,
wherein the battery system is configured to supply the power to the storage device in the off-state in response to the battery control signal, and
wherein the storage device is configured to perform a data management operation in response to the data retention management signal.

12. The electronic system of claim 11, wherein the electronic device is configured to determine the data management period further based on an exposure time table of the temperature of the storage device and the data retention parameter.

13. The electronic system of claim 11, wherein for each time period of a plurality of time periods, the outside temperature corresponds to a temperature outside of the vehicle for that time period,
wherein the electronic device is configured to:
estimate a temperature of the storage device in each time period of the plurality of time periods based on an outside temperature of each time period of the plurality of time periods; and
determine the data management period of the storage device in the off state based on the estimated temperature of the storage device in each time period of the plurality of time periods and the data retention parameter.

14. The electronic system of claim 13, wherein the data retention parameter includes a data retention time and an acceleration constant according to a reference temperature.

15. The electronic system of claim 14, wherein the electronic device is configured to determine the data management period further based on a scale factor table of the temperature of the storage device in each time period of the plurality of time periods and on the acceleration constant.

16. The electronic system of claim 11, wherein the data management operation includes at least one of a scan operation, a refresh operation, or a reclaim operation.

17. The electronic system of claim 11, wherein the electronic device is configured to:
send environment information of the storage device to a cloud server in response to an error signal corresponding to corrupted data of the storage device;
receive a defense code sequence corresponding to the environment information from the cloud server; and
send the received defense code sequence to the storage device,
wherein the storage device is configured to recover the corrupted data based on the defense code sequence.

18. An operating method of an electronic device installed in a vehicle, the method comprising:
receiving information about an outside temperature, wherein the outside temperature is a temperature outside of the vehicle;
estimating a temperature of a storage device based on the outside temperature and a preset temperature offset so as to provide an estimated temperature of the storage device;
determining a data management period of the storage device in an off state based on the estimated temperature of the storage device and a data retention parameter; and
when the data management period is reached, outputting a battery control signal to a battery system and outputting a data management signal to the storage device.

19. The method of claim 18, further comprising:
receiving an error signal corresponding to corrupted data of the storage device;
sending environment information of the storage device to a cloud server in response to the error signal;
receiving a defense code sequence from the cloud server; and
sending the defense code sequence to the storage device.

20. The method of claim 18, further comprising:
receiving information about an outside temperature and information about a temperature of the storage device during driving of the vehicle; and
updating the temperature offset based on the outside temperature and the temperature of the storage device provided during the driving of the vehicle.
